(19) United States
(12) Patent Application Publication
(10) Pub. No.: US 2017/0211529 A1
(43) Pub. Date: Jul. 27, 2017

(54) FUEL SUPPLY DEVICE FOR V-TYPE TWO-CYLINDER GENERAL PURPOSE ENGINE

(71) Applicant: NIKKI CO., LTD., Kanagawa-ken (JP)

(72) Inventors: Kazuki Kimura, Kanagawa - ken (JP); Ryota Adachi, Kanagawa - ken (JP); Teruyuki Wakabayashi, Kanagawa - ken (JP); Yukinori Suematsu, Kanagawa - ken (JP); Shouta Tanigawa, Kanagawa - ken (JP)

(21) Appl. No.: 15/411,956

(22) Filed: Jan. 20, 2017

(30) Foreign Application Priority Data
Jan. 22, 2016 (JP) 2016-010507
May 17, 2016 (JP) 2016-098616

(51) Int. Cl. F02M 35/116; F02D 41/20; F02M 35/10; F02M 61/14; F02B 75/22; F02B 75/02

(52) U.S. Cl. CPC F02M 35/116; F02B 75/22; F02B 75/02; F02M 35/10216; F02M 35/10091; F02M 61/145; F02D 41/20; F02M 35/10085; F02B 2075/1808

(57) ABSTRACT

A fuel supply device may include an intake manifold having both ends thereof respectively connected to intake openings of cylinder heads of each of the cylinders in a V-type two-cylinder general-purpose engine, a throttle body connected to a connection portion of the intake manifold, a fuel injection valve disposed in the throttle body and having nozzles for uniformly injecting fuel to inside of the intake port or to an inner wall surface of the intake port of each of the cylinders through the connection portion of the intake manifold, and a throttle valve disposed to the throttle body upstream of the fuel injection valve.

### CROSS-REFERENCE TO RELATED APPLICATIONS

This application claims priority to Japanese Application Nos. JP2016-010507, filed Jan. 22, 2016, and JP2016-098616, filed May 17, 2016, which are hereby incorporated by reference in their entirety.

### TECHNICAL FIELD

The present invention relates to a fuel supply device for a V-type two-cylinder general-purpose engine used in a lawnmower, a power generator, a power machine for marine sports, and the like.

### BACKGROUND

There has been known a conventional general-purpose engine used in a lawnmower, a power generator, a power machine for marine sports, and the like. In particular, due to a use purpose thereof, miniaturization and a cost reduction have been demanded of the general-purpose engine. Such engine often uses a vaporizer as a fuel supply means therefor.

However, providing the vaporizer with a function conforming to a recent exhaust control measure for an engine has been very difficult due to limitation of a mechanism. In particular, in a two-cylinder engine, a balance of a mixing ratio of fuel and air (air fuel ratio), or a cylinder distribution, may be easily changed, whereby a configuration is used in which each of the cylinders is provided with an independent vaporizer.

For example, in a multi-cylinder engine used in an expensive automobile, the exhaust control measure and the cylinder distribution are made possible by using, in place of the vaporizer, a means for supplying fuel to an engine by injecting the fuel from a fuel injection valve to inside of an intake passage of the engine. In particular, by using a so-called multi point injection (MPI) method in which the fuel injection valve is installed in each branch pipe of an intake manifold, it is possible to adjust a fuel supply amount for each of the cylinders; however, it is an expensive fuel supply device difficult to be used as the general-purpose engine of which the cost reduction has been demanded.

Accordingly, for example, Japanese Unexamined Patent Publication No. 2003-106246 discloses a fuel supply means for a general-purpose engine that supplies fuel from one fuel injection valve installed in a region between two intake passages, which are connected to each cylinder of a two-cylinder engine.

The fuel supply device for the general-purpose engine disclosed in this official journal achieves a cost reduction by using a so-called single point injection (SPI) method in which the fuel is injected to each of the cylinders of the two-cylinder engine by using one fuel injection valve. As illustrated in FIG. 14, a two-cylinder engine 4a has two cylinders C₁ and C₂ respectively connected to two branch pipes M₁ and M₂ of an intake manifold 3a to which a throttle valve 5a is connected. One fuel injection valve 11a is installed in a region on an upstream side of throttle bodies 2a and 2a having two passage portions T₁ and T₂ to which the throttle valve 5a is disposed. Since the fuel injection valve 11a is disposed to the throttle bodies 2a, the cost reduction may be achieved due to a reduction of the number of components; however, since the fuel supply device requires the intake manifold 3a having the two branch pipes M₁ and M₂ connected to the cylinder of the engine as well as the throttle bodies 2a to which the two throttle valves 5a and 5a are disposed, the number of components is not sufficiently reduced. Furthermore, the fuel supply device requires fuel guide paths F₁ and F₂ for allowing the injected fuel from the fuel injection valve 11a to flow through the passage portions T₁ and T₂, whereby the fuel supply device has a complicated configuration as a whole and is not easy to be manufactured.

In particular, since the throttle valves 5a and 5a and the intake manifold 3a having the branch pipes M₁ and M₂ are disposed to downstream positions after divergence of the fuel injection valve 11a, even though the injected fuel from the one fuel injection valve 11a is divided into two equal amounts by an accurate structure into the fuel guide paths F₁ and F₂, there is a problem in that an intake amount changes with a load on the engine, and there may be a difference in the air fuel ratio of each of the cylinders by the time the fuel reaches the cylinder. Furthermore, the fuel supply device disclosed in the above-described official journal may be installed in a parallel-type two-cylinder engine, which has a space for installing the fuel supply device between the cylinders; however, installation thereof in the V-type two-cylinder general-purpose engine, which is intended to be further miniaturized, is difficult because a space between mutual engine heads is formed to be narrow.

In Utility Model Application Publication No. 63-87271, there is disclosed a fuel supply device in which a throttle valve is disposed upstream of a fuel injection valve. In the disclosed fuel supply device, atomized fuel injected from the fuel injection valve is guided from a riser unit to right and left intake branch pipes and is supplied to each of the cylinders; however, this fuel supply device is not applicable to an air-cooling type general-purpose engine having no riser unit.

Among the V-type two-cylinder general-purpose engines, there are a vertical output shaft type engine used, for example, in a riding-type lawnmower and the like, and a horizontal output shaft type engine used, for example, in a power generator. Between an intake manifold of the vertical output shaft type engine and an intake manifold of the horizontal output shaft type engine, an attachment angle of a throttle body is different by 90 degrees. Thus, in a case where the throttle body installed with the fuel injection valve having the same configuration is used, an injection direction of the fuel injected from the fuel injection valve is not suitable for the intake manifold of each type. Thus, it is necessary to prepare an individual throttle body according to the intake manifold of each of the output shaft types, which has been a problem in terms of improving production efficiency through standardization of components.

### SUMMARY

The present invention has been devised to solve the problem existing in the conventional fuel supply device for the V-type two-cylinder general-purpose engine. An embodiment of the present invention provides a fuel supply device for the V-type two-cylinder general-purpose engine with which it is possible to meet an exhaust gas control by making fuel distribution to each of cylinders uniform with the small number of components at a low price. The fuel supply device is installable in the V-type two-cylinder general-purpose engine in which a space between engine heads is formed to be narrow. The fuel supply device has an intake manifold having an opening formed therein to which a vaporizer can be attached in place of the throttle body, whereby it is easy to be designed, and the standardization of components and alteration may be easily carried out. The fuel supply device is also capable of achieving an optimal cylinder distribution having no difference in an air fuel ratio of each of the cylinders.

The embodiment of the present invention devised to solve the problem includes: one intake manifold having both ends thereof respectively connected to intake ports of a cylinder head of each of the cylinders of the V-type two-cylinder general-purpose engine, the intake ports being formed in symmetrical positions interposing a second line segment being at a right angle to a first line segment connecting a centerline of each of cylinders, the intake manifold having an opening formed in an intermediate position of the first line segment diverged in a direction of both of the cylinders interposing the second line segment; one throttle body having an intake hole connected to the opening of the intake manifold and extending in a direction of the second line segment; a fuel injection valve disposed to the throttle body and having a two-direction nozzle configured to inject fuel uniformly to inside of the intake port or to an inner wall surface of the intake port of each of the cylinders through the opening of the intake manifold, the two-direction nozzle being disposed to oppose each other and facing outward; and a throttle valve disposed to the intake hole formed in the throttle body upstream of the fuel injection valve.

The embodiment of the present invention includes one intake manifold, one throttle body, one fuel injection valve installed in the throttle body, and one throttle valve, and with which it is possible to meet the exhaust gas control by making the fuel distribution to each of the cylinders uniform with the small number of components at a low price, and it is installable in the V-type two-cylinder general-purpose engine in which the space between engine heads is formed to be narrow.

According to the embodiment of the present invention, the intake manifold has a connection portion formed therein to which a vaporizer can be attached in place of the throttle body, whereby it is easy to be designed, and the standardization of components and alteration may be easily carried out.

Furthermore, according to the embodiment of the present invention, in a case where the opening of the intake manifold is diverged in a direction of both of the cylinders interposing a second line segment, it is possible to supply fuel injected from the one fuel injection valve and distributed in two directions in an equal amount to an intake port or an inner wall surface of the intake port of each of the cylinders, and an intake caused by a combustion stroke in one of the cylinders does not affect a combustion stroke in the other of the cylinders.

Still furthermore, the injection direction of each of the nozzles of the fuel injection valve having the two-direction nozzle is configured to be at a predetermined angle relative to the axial center of the injection valve so as to maintain the fixed relationship in advance corresponding to the attachment angle formed by the axial center of the fuel injection valve and the axial center of the intake hole formed in the throttle body, the fuel injected from the two-direction nozzle is injected uniformly to the diverged opening of the intake manifold, in addition, the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body, and the fuel injected from the two-direction nozzle is applicable to an intake manifold installed in a vertical output shaft type engine and an intake manifold installed in a horizontal output shaft type engine by configuring such that the fuel injection valve is attachable by inverting by 180 degrees in a direction orthogonal to the axial center of the intake hole of the throttle body.

In particular, the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body, the fuel injected from the two-direction nozzle is applicable to the intake manifold installed in the vertical output shaft type engine and the intake manifold installed in the horizontal output shaft type engine by configuring such that the fuel injection valve is attachable by inverting by 180 degrees in a direction orthogonal to the axial center of the intake hole of the throttle body, and a protrusion position of a connector protruding from a main body case of the fuel injection valve is protruded in an eccentric angle position centering on the axial center of the fuel injection valve, an attachment direction of the fuel injection valve to the throttle body connected to the intake manifold of the vertical output shaft type engine and the intake manifold of the horizontal output shaft type engine can be visually checked.

Still furthermore, the fuel injection valve performs an injection before an intake stroke of each of the cylinders of the engine, and a total amount thereof is a fuel supply amount to the engine. By making mixture distribution of air and fuel to each of the cylinders equal by changing a pulse width of injector drive, which determines an injection flow rate to each of the cylinders, it is possible to achieve optimal cylinder distribution of the total amount thereof having no difference in the air fuel ratio of each of the cylinders.

According to the embodiment of the present invention, it is possible to meet the exhaust gas control by making fuel distribution to each of the cylinders uniform with the small number of components at a low price, and it is installable in the V-type two-cylinder general-purpose engine in which the space between engine heads is formed to be narrow. According to the embodiment of the present invention, the intake manifold has a connection portion formed therein to which the vaporizer can be attached in place of the throttle body, whereby it is easy to be designed, and the standardization of components and alteration may be easily carried out. Furthermore, it is possible to achieve an optimal cylinder distribution having no difference in the air fuel ratio of each of the cylinders.

### BRIEF DESCRIPTION OF DRAWINGS

FIG. 1 is a schematic sectional view illustrating a preferred embodiment of the present invention;

FIG. 2 is a perspective view illustrating the embodiment of FIG. 1;

FIG. 3 is an exploded perspective view illustrating the embodiment of FIG. 1;

FIG. 4 is a plan view illustrating the embodiment of FIG. 1;

FIG. 5 is a partial enlarged view illustrating a rear face of the embodiment of FIG. 1;

FIG. 6 is an explanatory diagram illustrating fuel injection timing of a conventional V-type two-cylinder general-purpose engine installed with a fuel injection valve in each cylinder and fuel injection timing of the embodiment of FIG. 1;

FIG. 7 is a perspective view illustrating a different embodiment of the present invention;

FIG. 8 is an exploded perspective view illustrating the embodiment of FIG. 7;

FIG. 9 is a plan view illustrating the embodiment of FIG. 7;

FIG. 10 is a partial enlarged view illustrating a rear face of the embodiment of FIG. 7;

FIG. 11 is an exploded perspective view illustrating another different embodiment of the present invention;

FIGS. 12A to 12C are partially-omitted longitudinal section views illustrating an injection state in the embodiment of FIG. 7 and the embodiment of FIG. 11;

FIG. 13 is a perspective view illustrating a fuel injection valve used in the embodiments of FIGS. 7 and 11; and

FIG. 14 is an explanatory diagram illustrating a conventional example.

### DETAILED DESCRIPTION

Hereinafter, a preferred embodiment of the present invention is described in detail with reference to the drawings.

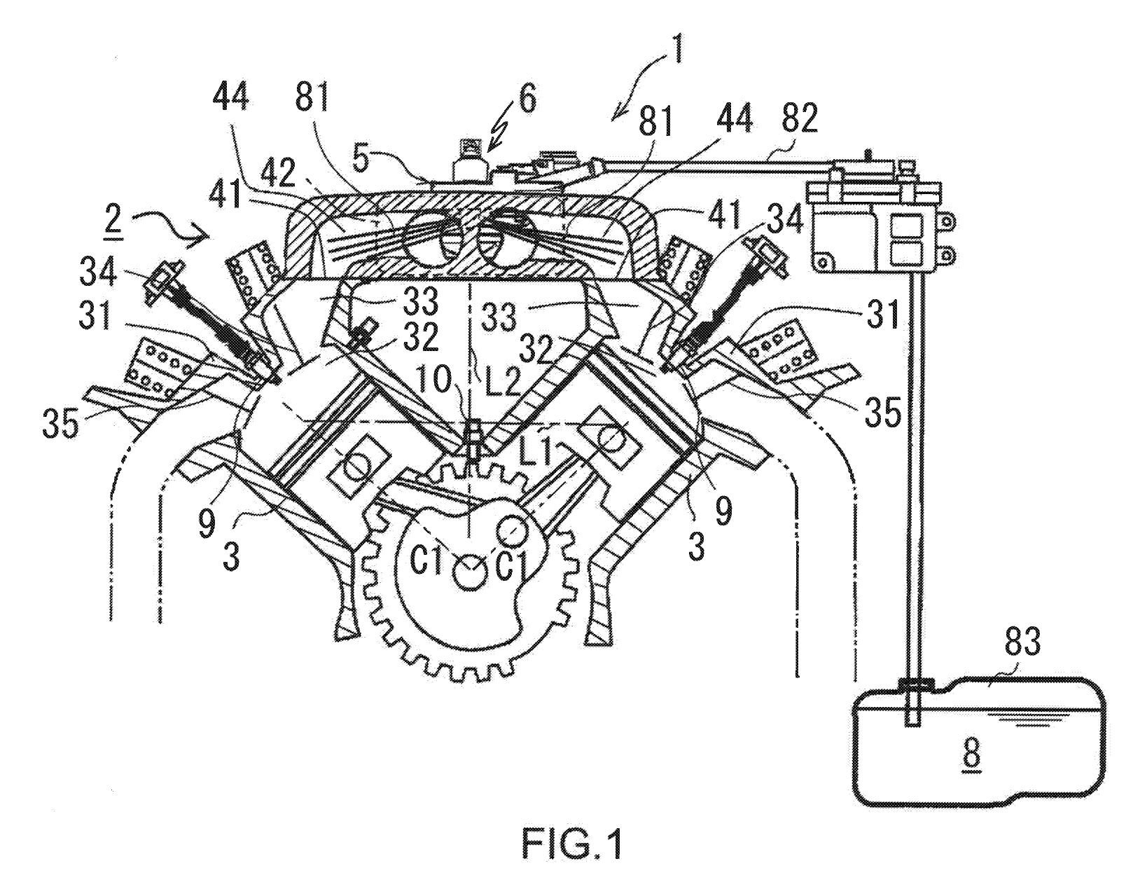

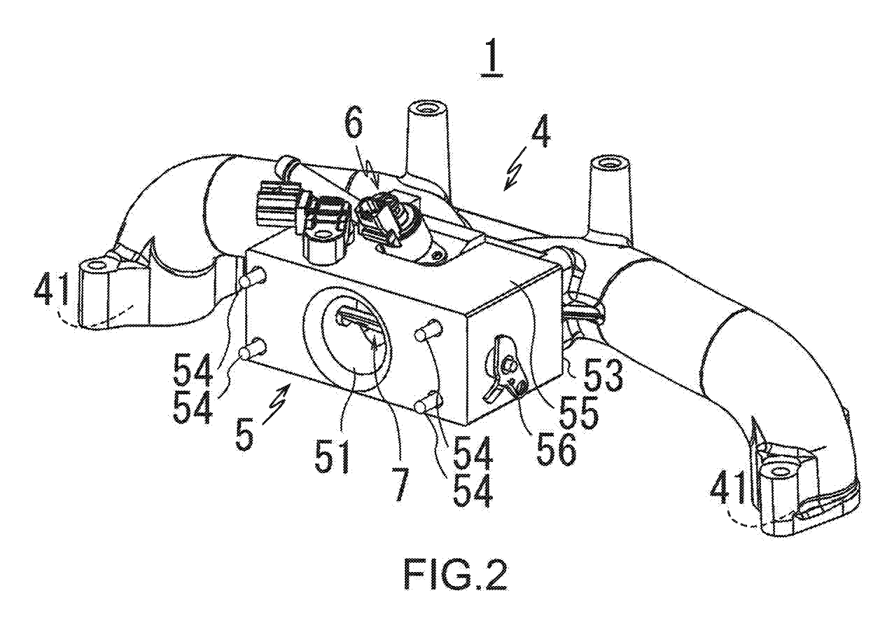

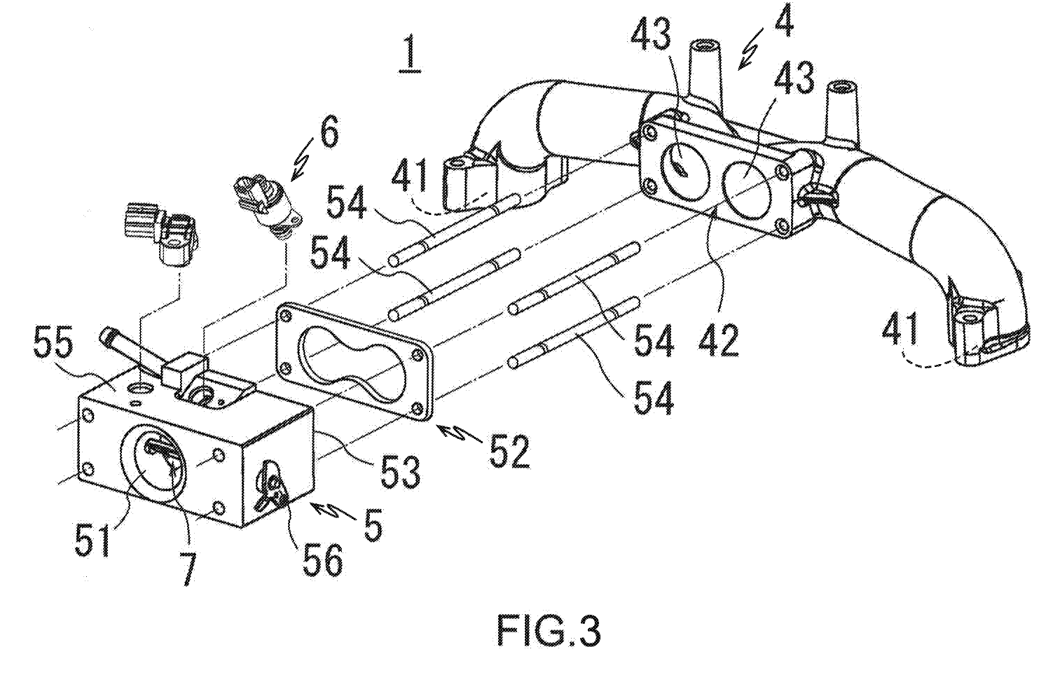

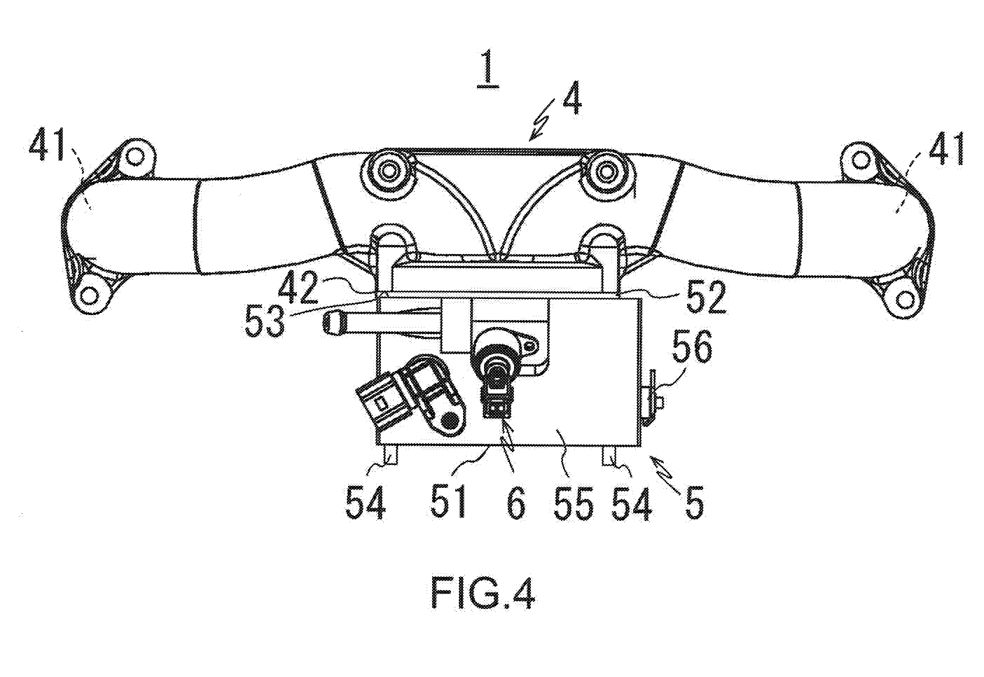

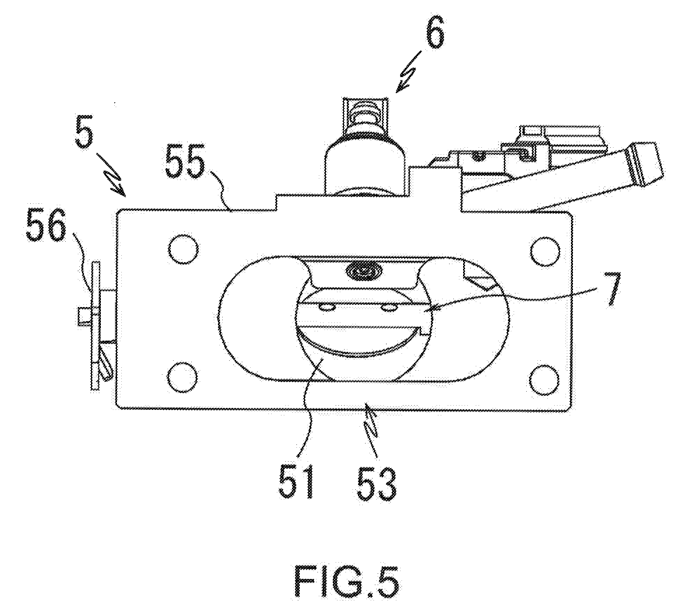

FIGS. 1 to 6 illustrate a preferred embodiment of the present invention carried out in a V-type cylinder general-purpose engine of a vertical output shaft type used, for example, in a riding-type lawnmower and the like. A fuel supply device 1 is installed in an air cooling type general-purpose engine having cylinders 3 and 3 with a bore angle of 90 degrees, for example, of a V-type two-cylinder general-purpose engine 2. Mainly, the fuel supply device 1 is constituted of one intake manifold 4 having openings 41 and 41 at both ends thereof, which are connected to cylinder heads 31 and 31 of the cylinders 3 and 3 between intake openings 32 and 32, and one throttle body 5 connected to a planar connection portion 42 formed in an intermediate position of the intake manifold 4.

More in detail, as illustrated in FIG. 1, the intake manifold 4 has the openings 41 and 41 at both ends thereof connected and air-tightly communicated with the intake openings 32 and 32, respectively. The intake openings 32 and 32 are formed in symmetrical positions interposing a second line segment L2, which is at a right angle to a first line segment L1 connecting centerlines C1 and C1 of each of the cylinders 3 and 3 of the V-type two-cylinder general-purpose engine 2.

In this embodiment, the connection portion 42 formed in the intake manifold 4 is formed in a center position in a length direction of the intake manifold 4 (center of the first line segment L1) and in a direction at the right angle to the line segment L1 (horizontal direction in the drawing). Thus, decreasing a space in a height direction in the drawing is possible, and the connection portion 42 may be formed anywhere as long as it is in the center position in the length direction in a periphery direction.

In this embodiment, openings 43 and 43 formed in the connection portion 42 of the intake manifold 4 are constituted of circular window holes formed so as to oppose each other interposing a centerline in a length direction of the connection portion 42 having a wide rectangular shape. Inside thereof, at a center position of the first line segment L1, the openings 43 and 43 are divided into intake passages 44 and 44 respectively connected to intake ports 33 and 33 continuing to the intake openings 32 and 32 of the cylinders 3 and 3.

Then, in this embodiment, the throttle body 5 has a circular intake hole 51 having the same diameter as the circular openings 43 and 43 at a center position thereof. Interposing a separator member 52 having a predetermined thickness, a leading end surface 53 is adhered to the connection portion 42 of the intake manifold 4 with four fixing screws 54.

In this embodiment, the intake hole 51 formed in the throttle body 5 has a wide oval shape at the leading end surface 53 to match the openings 43 and 43 formed in the intake manifold 4; however, the intake hole 51 is converged toward the center in the middle toward a rear end surface and is formed into a circular shape having the same diameter as the oval shape. To a fuel injection valve attachment hole 57 having an axial center of a predetermined angle relative to an axial center of the intake hole 51 penetrating through the intake hole 51 formed in a top wall 55 at a frontward position of the converged part, the fuel injection valve 6 is provided. The fuel injection valve 6 has an injecting unit 61 in which two-direction nozzles 62 and 62 that inject sprayed fuel 81 and 81 toward the intake passages 44 and 44 from the openings 43 and 43 of the intake manifold 4. One throttle valve 7 is disposed to the converged circular part of the intake hole 51 positioned upstream of the fuel injection valve 6, whereby reduction of the number of components has been achieved.

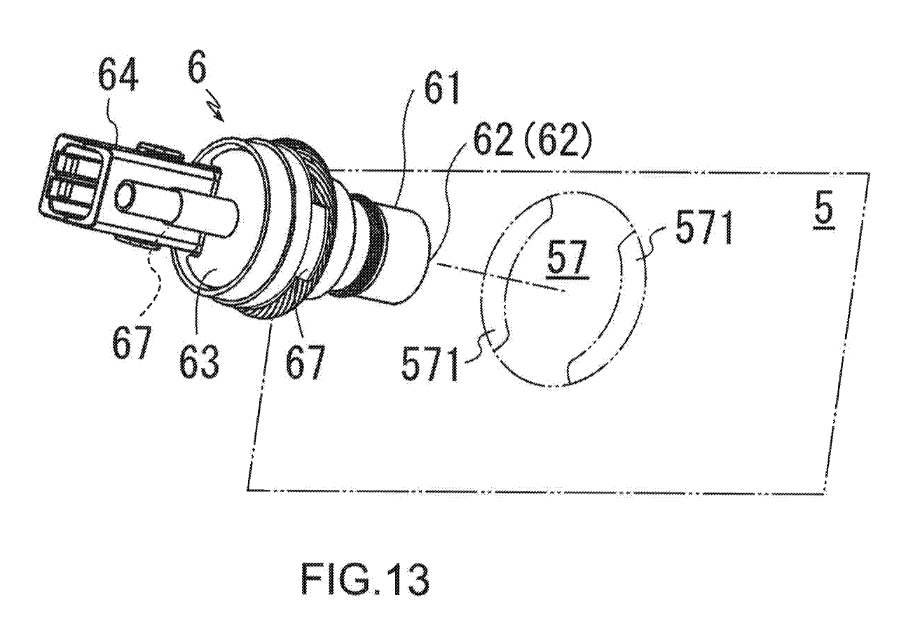

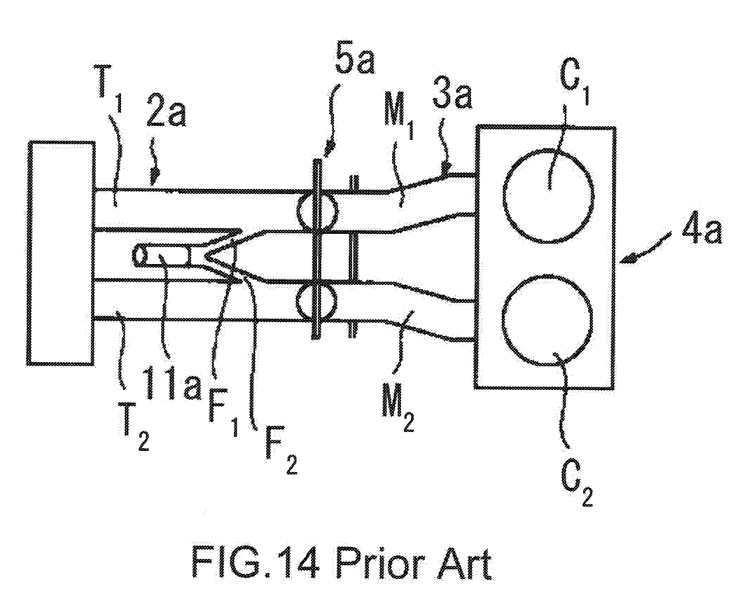

In particular, in this embodiment, as illustrated in FIGS. 1 to 6, an injection direction of each of the nozzles 62 of the fuel injection valve 6 is formed so as to maintain a fixed relationship in advance corresponding to an attachment angle of an axial center of the intake hole 51 formed in the throttle body 5 and an axial center of the fuel injection valve 6 formed in the throttle body 5. By attaching the fuel injection valve 6 at a predetermined rotation position centering on the axial center thereof (rotation position in which the two-direction nozzles 62 and 62 are symmetrical to each other interposing the axial center of the intake hole 51 in a direction in which the intake manifold 4 extends) and at a predetermined depth position to the fuel injection valve attachment hole 57, attachment can be made in a state where each of the nozzles 62 is adjusted in advance such that the injection direction of the sprayed fuel 81 (see FIG. 13) is an appropriate angle, whereby it is very convenient.

Note that in the drawings, a reference numeral 82 denotes a fuel supply pipe for supplying fuel 8 pooled in a fuel tank 83 to the fuel injection valve 6 installed in the throttle body 5, a reference numeral 56 denotes a throttle lever for controlling the throttle valve 7 installed in the throttle body 5, a reference numeral 9 denotes an ignition plug installed in the cylinder heads 31 and 31 of the cylinders 3 and 3, reference numerals 34 and 34 denote intake valves installed in the cylinders 3 and 3, and reference numerals 35 and 35 denote exhaust valves.

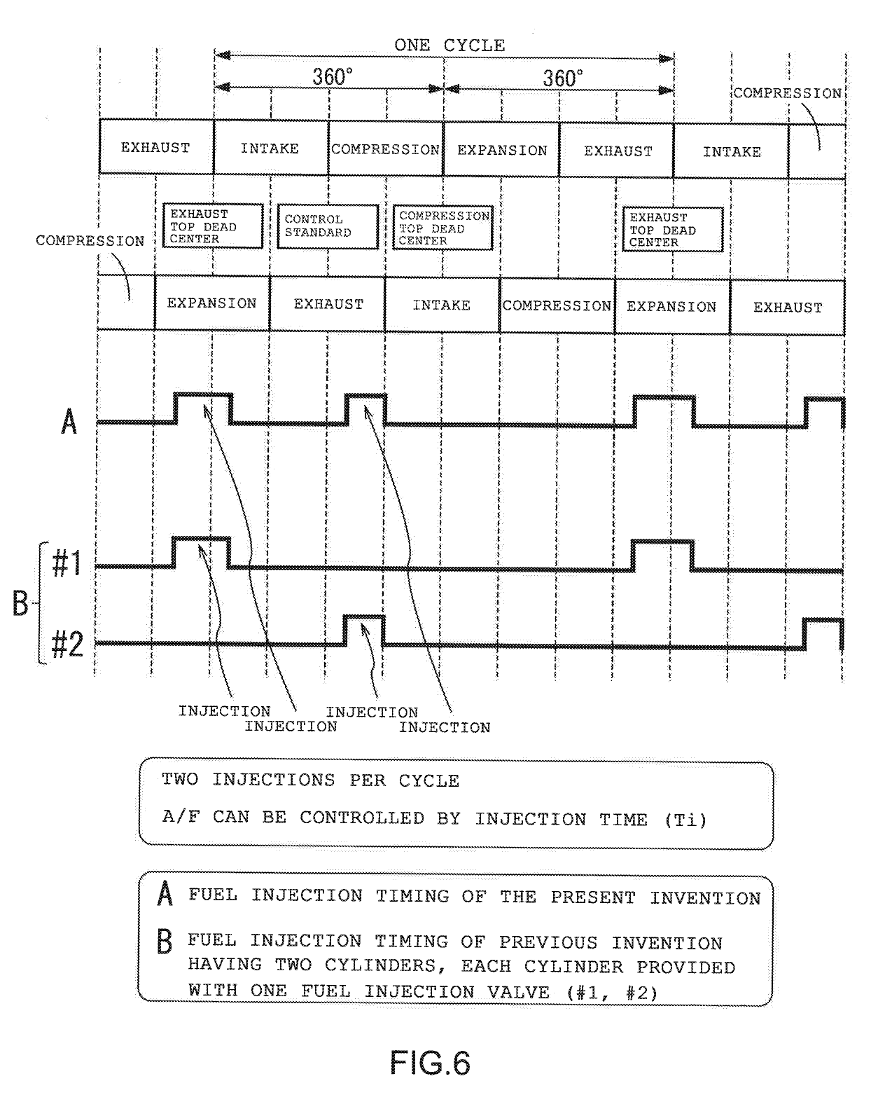

FIG. 6 is an explanatory diagram illustrating fuel injection timing of a conventional V-type two-cylinder general-purpose engine installed with a fuel injection valve in each cylinder and fuel injection timing of the embodiment of FIG. 1. The fuel injection timing of this embodiment is performed before an intake stroke in each of the cylinders 3 and 3 detected by a crank position sensor 10. From the nozzles 62 and 62 of the fuel injection valve 6, atomized fuel is sprayed toward the intake ports 33 and 33 in an equal amount. At this time, the sprayed fuel stays in the intake ports 33 and 33 or on an inner wall surface of the intake ports 33 and 33. When each of the cylinders 3 and 3 enters the intake stroke, a cycle is repeated in which the fuel is sucked into the cylinders 3 and 3, compressed, ignited, expanded, and evacuated. In this embodiment, each of the cylinders 3 and 3 has the intake stroke that is not coincident, whereby puling of the fuel staying in the intake ports 33 and 33 occurs.

Accordingly, in this embodiment, each time the V-type two-cylinder general-purpose engine 2 makes one rotation, one fuel injection is performed. That is, the fuel injection is performed before the intake stroke of each of the cylinders 3 and 3, and a total amount of the fuel injection is a fuel supply amount to the V-type two-cylinder general-purpose engine 2. By making mixture distribution of air and fuel to each of the cylinders 3 and 3 equal and by changing a pulse width of injector drive, which is a determining element of an injection flow rate to each of the cylinders, it is possible to achieve optimal cylinder distribution of the total amount having no difference in an air fuel ratio of each of the cylinders 3 and 3.

Furthermore, in this embodiment, the throttle valve 7 is disposed to the intake hole 51 of the throttle body 5 upstream of the fuel injection valve 6, whereby variation in the supply amount due to adherence of injected fuel to the throttle valve 7 is not caused.

Furthermore, this embodiment includes one intake manifold 4, one throttle body 5, one fuel injection valve 6 installed in the throttle body 5, and one throttle valve 7, whereby it is possible to meet an exhaust gas control by making fuel distribution to each of the cylinders uniform with the small number of components at a low price. The fuel supply device is installable in the V-type two-cylinder general-purpose engine in which a space between engine heads is formed to be narrow.

Furthermore, in this embodiment, as an intake manifold, a conventional intake manifold installed with one vaporizer in an opening formed in the center can be used as it is. It is also possible to use, as it is, an installation port (not illustrated) of the intake manifold installed with a conventional vaporizer as the connection portion 42. It is also possible to install the throttle body 5 of this embodiment in the intake manifold installed with the conventional vaporizer. By using the V-type two-cylinder general-purpose engine having a conventional vaporizer specification, it is possible to manufacture at a further reduced cost, and by removing the vaporizer from the intake manifold of the V-type two-cylinder general-purpose engine having the conventional vaporizer specification and by installing the throttle body 5 of this embodiment in place thereof, an improvement of the vaporizer specification can be made easily.

In addition, in this embodiment, since the openings 43 and 43 of the intake manifold 4 are diverged in a direction of both of the cylinders 3 and 3, it is possible to supply fuel injected from one fuel injection valve 6 and distributed in two directions in an equal amount to each of the intake ports 33 and 33 or an inner wall surface of the intake ports 33 and 33, and an intake caused by a combustion stroke in one of the cylinders 3 does not affect a combustion stroke in the other of the cylinders 3.

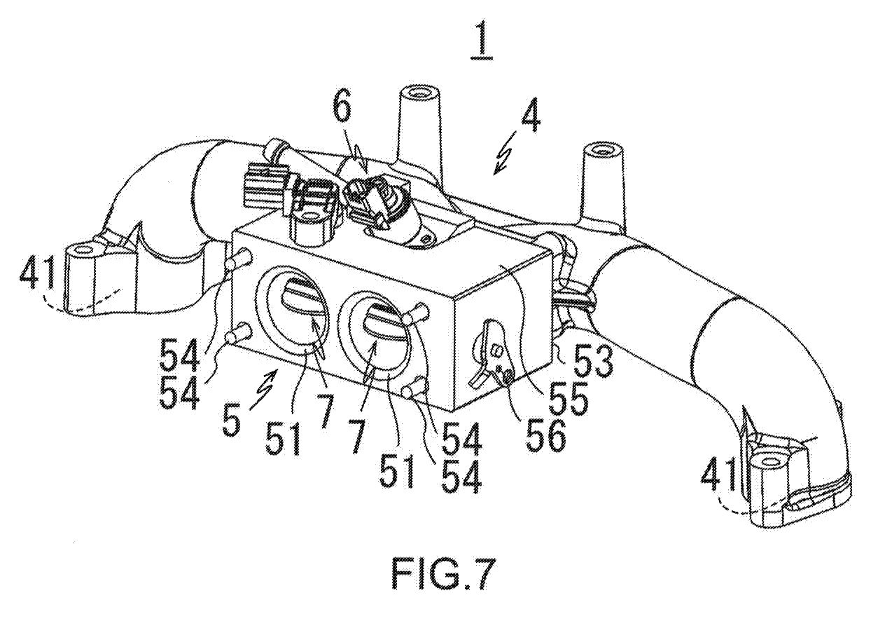

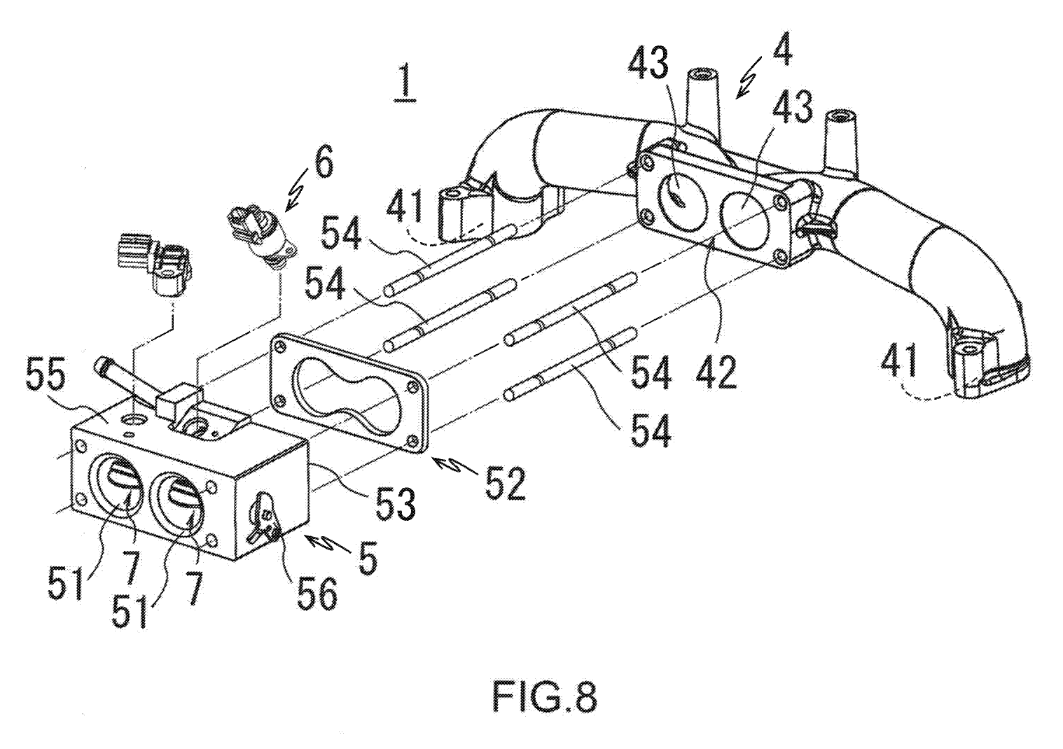

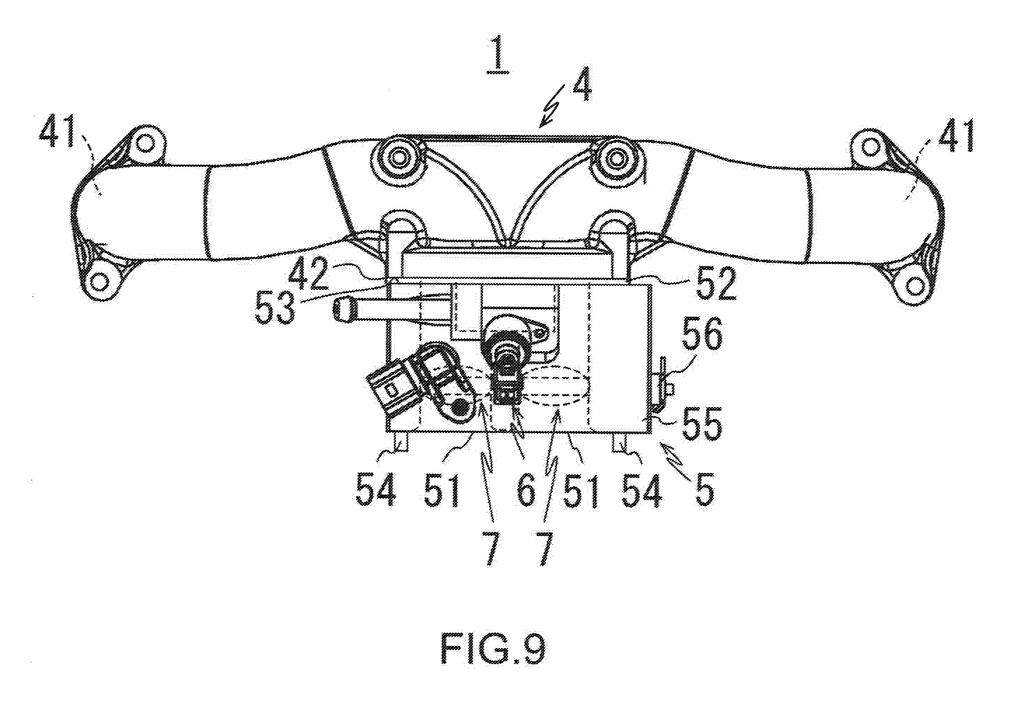

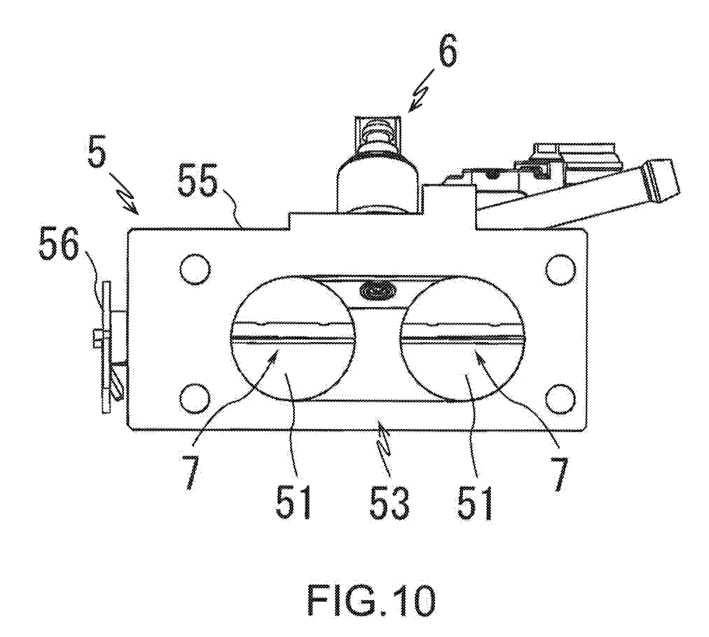

In FIGS. 7 to 10, a different embodiment of the present invention is illustrated, and an overall configuration thereof is substantially the same as that of the embodiment illustrated in FIGS. 1 to 6; however, in the embodiment illustrated in FIGS. 1 to 6, the intake hole 51 formed in the throttle body 5 has the wide oval shape at the leading end surface 53 to match the openings 43 and 43 formed in the intake manifold 4; however, the intake hole 51 is converged toward the center in the middle toward the rear end surface and is formed to be a circular shape having the same diameter as the oval shape. In contrast, this embodiment is different in that there is formed a pair of intake holes 51 and 51 to which the throttle valves 7 and 7 is disposed respectively matching the openings 43 and 43 formed in the intake manifold 4.

According to this embodiment, unlike in the embodiment illustrated in FIGS. 1 to 6 in which the intake hole 51 formed in the throttle body 5 is diverged into two in the middle and is connected to each of the openings 43 and 43 formed in the intake manifold 4, there is formed the intake holes 51 and 51 respectively connecting to the openings 43 and 43 formed in the intake manifold 4. Thus, one fuel injection valve 6 exposed toward a frontward position of a diverging portion is installed to the top wall 55, the diverged intake holes 51 and 51 positioned upstream of the fuel injection valve 6 of the intake hole 51 match the openings 43 and 43 formed in the intake manifold 4, and the separate throttle valves 7 and 7 are disposed in a mutually interlocking manner to the intake holes 51 and 51, respectively, whereby it is possible to securely spray the sprayed fuel 81 and 81 injected from the fuel injection valve 6 toward the intake ports 33 and 33 or the inner wall surface of the intake ports 33 and 33 from the openings 43 and 43 formed in the intake manifold 4 through the divided intake passages 44 and 44.

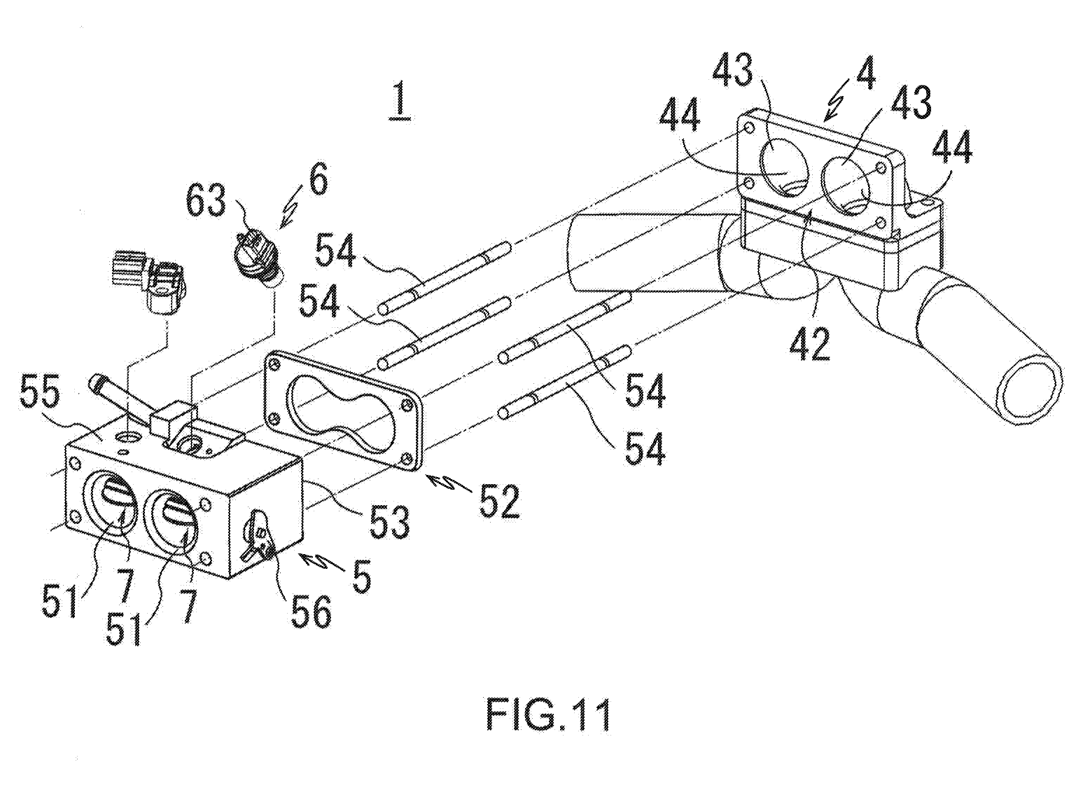

Still furthermore, FIG. 11 is an exploded perspective view illustrating an embodiment of the present invention carried out in a vertical output shaft type engine (not illustrated) used, for example, in a power generator and the like. An overall configuration and a function and an effect thereof are substantially the same as those of the embodiment illustrated in FIGS. 7 to 10 used in a horizontal output shaft type engine; however, the openings 43 and 43 formed in the connection portion 42 of the intake manifold 4 is not immediately diverged into the right and left to be coupled to the intake ports 33 and 33 of each of the cylinders 3 and 3 of the engine as illustrated in FIG. 7. There is a difference in that in the vertical output shaft type engine according to this embodiment, the intake manifold 4 is bent once by 90 degrees in a right angle direction (downward in the drawing) from the openings 43 and 43, diverged into the right and left, and connected to the intake passages 44 and 44 of each of the intake ports (not illustrated) of the cylinder.

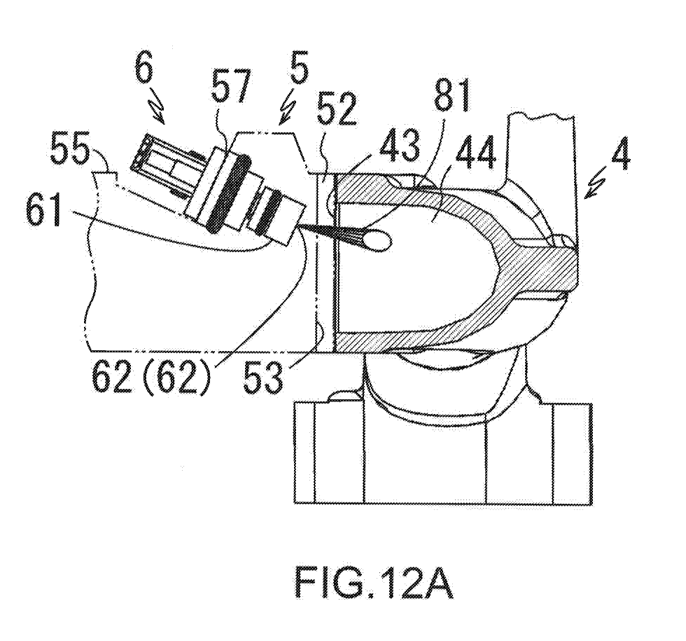

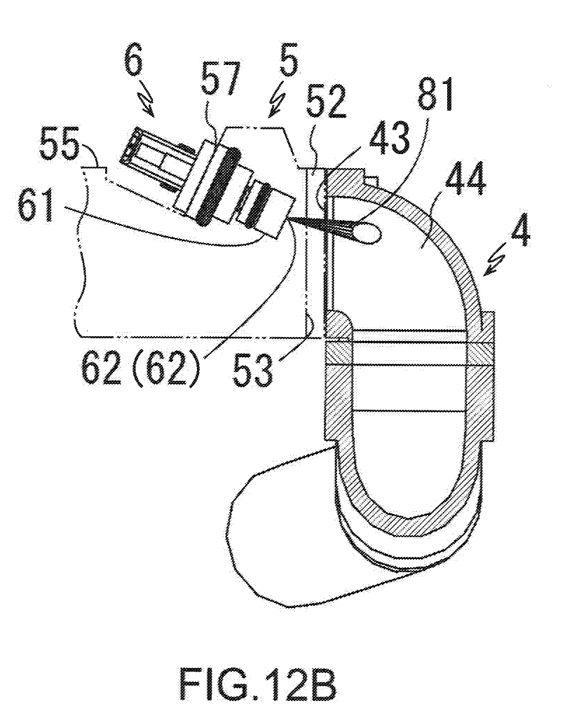

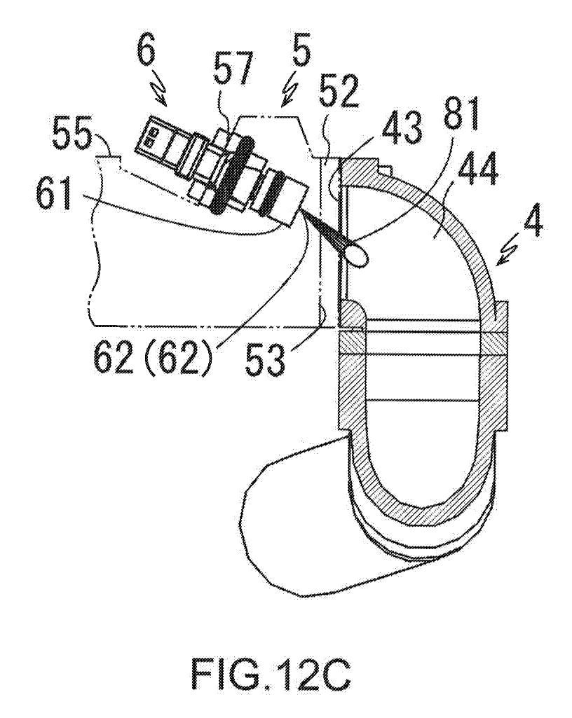

In this embodiment, however, parts other than the intake manifold 4 is not much different from the embodiment illustrated in FIGS. 7 to 10, or the embodiment used in the horizontal output shaft type engine, whereby for other parts, it is possible to reduce a manufacturing cost by standardization of the component whenever possible. However, as illustrated in FIG. 12A, in the embodiment used in the vertical output shaft type engine, the fuel injection valve 6 installed in the throttle body 5 is adjusted in an appropriate angle such that the two-direction nozzles 62 (62) inject to the center in a vertical direction in the drawing of the intake manifold 4 so as to maintain a fixed relationship in advance corresponding to an attachment angle formed by the axial center of the fuel injection valve 6 and the axial center of the intake hole 51 formed in the throttle body 5, an attachment angle in a horizontal direction (vertical direction in the drawing) of the fuel injection valve attachment hole 57 is adjusted to be an appropriate angle at a predetermined three-dimensional angle relative to the axial center of the injection valve 6. Using this directly in the embodiment illustrated in FIG. 11, which is used in the horizontal output shaft type engine, as illustrated in FIG. 12B, since the intake manifold 4 is bent once by 90 degrees in the right angle direction (downward in the drawing) from the openings 43 and 43 and diverged into the right and left, the sprayed fuel 81 injected from the two-direction nozzles 62 (62) of the fuel injection valve 6 hits a bent portion of the intake manifold 4, whereby it cannot be efficiently supplied to the engine.

Accordingly, as illustrated in FIG. 12C, by disposing the fuel injection valve 6 to the fuel injection valve attachment hole 57 of the throttle body 5 at a position in which the fuel injection valve 6 is rotated by 180 degrees centering on the axial center thereof, the injection direction of the fuel by the two-direction nozzles 62 (62) is made applicable to the intake manifold 4 installed in the vertical output shaft type engine.

That is, as described above, a difference between the horizontal output shaft type intake manifold 4 illustrated in FIG. 12A and the vertical output shaft type intake manifold 4 illustrated in FIGS. 12B and 12C is in that whether it is diverged directly in the horizontal direction or is bent by 90 degrees and diverged in the horizontal direction. By disposing the fuel injection valve 6 to the fuel injection valve attachment hole 57 of the throttle body 5 at the position in which the fuel injection valve 6 is rotated by 180 degrees centering on the axial center thereof, it is possible to use the same throttle body 5 and the same fuel injection valve 6.

In particular, in this embodiment, as illustrated in FIG. 13, a protrusion position of a connector 64 protruding from a main body case 63 of the fuel injection valve 6 is protruded in an eccentric angle position centering on the axial center of the fuel injection valve, whereby an attachment direction of the fuel injection valve 6 to the throttle body 5 connected to the intake manifold of the vertical output shaft type and the intake manifold of the horizontal output shaft type can be visually checked.

Note, however, that in this embodiment, in attachment of the fuel injection valve 6 to the fuel injection valve attachment hole 57 formed in the top wall 55 of the throttle body 5, since it is necessary to insert and dispose the fuel injection valve 6 to a position in which the fuel injection valve 6 is rotated by 180 degrees centering on the axial center thereof, the attachment thereof can be implemented very easily not by using a screw but by using a well-known fastening means in which fitting and removing of the fuel injection valve 6 can be performed, for example, as illustrated, by protruding a plurality of flanges 571 and 571 at a predetermined angle and position from the opening of the fuel injection valve attachment hole 57, by protruding the flanges 67 and 67 to be rotary engaged with the flanges 571 and 571 from an outer periphery of an attachment portion of the fuel injection valve 6, and by rotating the flanges 67 and 67.

1. A fuel supply device for a V-type two-cylinder general-purpose engine, the fuel supply device comprising:
an intake manifold having both ends thereof respectively connected to intake ports of a cylinder head of each of the cylinders of the V-type two-cylinder general-purpose engine, the intake ports being formed in symmetrical positions interposing a second line segment being at a right angle to a first line segment connecting a centerline of each of cylinders, the intake manifold having an opening formed in an intermediate position of the first line segment diverged in a direction of both of the cylinders interposing the second line segment;
a throttle body having an intake hole connected to the opening of the intake manifold and extending in a direction of the second line segment;
a fuel injection valve disposed to the throttle body and having a two-direction nozzle configured to inject fuel uniformly to inside of the intake port or to an inner wall surface of the intake port of each of the cylinders through the opening of the intake manifold, the two-direction nozzle being disposed to oppose each other and facing outward; and
a throttle valve disposed to the intake hole formed in the throttle body upstream of the fuel injection valve.

2. The fuel supply device for the V-type two-cylinder general-purpose engine according to claim 1, wherein
the intake manifold has a connection portion formed therein to which a vaporizer can be attached in place of the throttle body.

3. The fuel supply device for the V-type two-cylinder general-purpose engine according to claim 1, wherein
an injection direction of each of nozzles of the fuel injection valve having the two-direction nozzle is configured to be at a predetermined angle relative to an axial center of the injection valve so as to maintain a fixed relationship in advance corresponding to an attachment angle formed by the axial center of the fuel injection valve and an axial center of the intake hole formed in the throttle body, and
the fuel injected from the two-direction nozzle is injected uniformly to the diverged opening of the intake manifold.

4. The fuel supply device for the V-type two-cylinder general-purpose engine according to claim 1, wherein
the injection direction of each of the nozzles of the fuel injection valve having the two-direction nozzle is configured to be at a predetermined angle relative to the axial center of the injection valve so as to maintain the fixed relationship in advance corresponding to the attachment angle formed by the axial center of the fuel injection valve and the axial center of the intake hole formed in the throttle body,
the fuel injected from the two-direction nozzle is injected uniformly to the diverged opening of the intake manifold,
the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body, and
the fuel injected from the two-direction nozzle is applicable to an intake manifold installed in a vertical output shaft type engine and an intake manifold installed in a horizontal output shaft type engine by configuring such that the fuel injection valve is attachable by inverting by 180 degrees in a direction orthogonal to the axial center of the intake hole of the throttle body.

5. The fuel supply device for the V-type two-cylinder general-purpose engine according to claim 1, or wherein
the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body,
the fuel injected from the two-direction nozzle is applicable to the intake manifold installed in the vertical output shaft type engine and the intake manifold installed in the horizontal output shaft type engine by configuring such that the fuel injection valve is attachable by inverting by 180 degrees in a direction orthogonal to the axial center of the intake hole of the throttle body, and
a protrusion position of a connector protruding from a main body case of the fuel injection valve is protruded in an eccentric angle position centering on the axial center of the fuel injection valve, an attachment direction of the fuel injection valve to the throttle body connected to the intake manifold of the vertical output shaft type engine and the intake manifold of the horizontal output shaft type engine can be visually checked.

6. The fuel supply device for the V-type two-cylinder general-purpose engine according to claim 1, wherein
the fuel injection valve performs an injection before an intake stroke of each of the cylinders of the engine,
a total amount of the injection is a fuel supply amount to an engine, and
in the total amount thereof, mixture distribution of air and fuel to each of the cylinders is made equal by changing a pulse width of injector drive being an important factor for determining an injection flow rate to each of the cylinders.

7. A fuel supply device for a V-type two-cylinder general-purpose engine, the fuel supply device comprising:
an intake manifold having both ends thereof respectively connected to intake ports of a cylinder head of each of the cylinders of the V-type two-cylinder general-purpose engine, the intake ports being formed in symmetrical positions interposing a second line segment being at a right angle to a first line segment connecting a centerline of each of cylinders, the intake manifold having an opening formed in an intermediate position of the first line segment diverged in a direction of both of the cylinders interposing the second line segment; and
a throttle body having an intake hole connected to the opening of the intake manifold and extending in a direction of the second line segment.

8. The fuel supply device for the V-type two-cylinder general-purpose engine according to claim 7, further comprising:
a fuel injection valve disposed to the throttle body and having a two-direction nozzle configured to inject fuel uniformly to inside of the intake port or to an inner wall surface of the intake port of each of the cylinders through the opening of the intake manifold, the two-direction nozzle being disposed to oppose each other and facing outward; and
a throttle valve disposed to the intake hole formed in the throttle body upstream of the fuel injection valve.

9. The fuel supply device for the V-type two-cylinder general-purpose engine according to claim 7, wherein
the intake manifold has a connection portion formed therein to which a vaporizer can be attached in place of the throttle body.

10. The fuel supply device for the V-type two-cylinder general-purpose engine according to claim 8, wherein
an injection direction of each of nozzles of the fuel injection valve having the two-direction nozzle is configured to be at a predetermined angle relative to an axial center of the injection valve so as to maintain a fixed relationship in advance corresponding to an attachment angle formed by the axial center of the fuel injection valve and an axial center of the intake hole formed in the throttle body, and
the fuel injected from the two-direction nozzle is injected uniformly to the diverged opening of the intake manifold.

11. The fuel supply device for the V-type two-cylinder general-purpose engine according to claim 8, wherein
the injection direction of each of the nozzles of the fuel injection valve having the two-direction nozzle is configured to be at a predetermined angle relative to the axial center of the injection valve so as to maintain the fixed relationship in advance corresponding to the attachment angle formed by the axial center of the fuel injection valve and the axial center of the intake hole formed in the throttle body,
the fuel injected from the two-direction nozzle is injected uniformly to the diverged opening of the intake manifold,
the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body, and
the fuel injected from the two-direction nozzle is applicable to an intake manifold installed in a vertical output shaft type engine and an intake manifold installed in a horizontal output shaft type engine by configuring such that the fuel injection valve is attachable by inverting by 180 degrees in a direction orthogonal to the axial center of the intake hole of the throttle body.

12. The fuel supply device for the V-type two-cylinder general-purpose engine according to claim 8, wherein
the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body,
the fuel injected from the two-direction nozzle is applicable to the intake manifold installed in the vertical output shaft type engine and the intake manifold installed in the horizontal output shaft type engine by configuring such that the fuel injection valve is attachable by inverting by 180 degrees in a direction orthogonal to the axial center of the intake hole of the throttle body, and
a protrusion position of a connector protruding from a main body case of the fuel injection valve is protruded in an eccentric angle position centering on the axial center of the fuel injection valve, an attachment direction of the fuel injection valve to the throttle body connected to the intake manifold of the vertical output shaft type engine and the intake manifold of the horizontal output shaft type engine can be visually checked.

13. The fuel supply device for the V-type two-cylinder general-purpose engine according to claim 8, wherein
the fuel injection valve performs an injection before an intake stroke of each of the cylinders of the engine,
a total amount of the injection is a fuel supply amount to an engine, and
in the total amount thereof, mixture distribution of air and fuel to each of the cylinders is made equal by changing a pulse width of injector drive being an important factor for determining an injection flow rate to each of the cylinders.

14. A fuel supply device for a V-type two-cylinder general-purpose engine, the fuel supply device comprising:
an intake manifold having both ends thereof respectively connected to intake ports of a cylinder head of each of the cylinders of the V-type two-cylinder general-purpose engine, the intake ports being formed in symmetrical positions interposing a second line segment being at a right angle to a first line segment connecting a centerline of each of cylinders, the intake manifold having an opening formed in an intermediate position of the first line segment diverged in a direction of both of the cylinders interposing the second line segment/

15. The fuel supply device for the V-type two-cylinder general-purpose engine according to claim 14, further comprising:
a throttle body having an intake hole connected to the opening of the intake manifold and extending in a direction of the second line segment.

16. The fuel supply device for the V-type two-cylinder general-purpose engine according to claim 15, further comprising:
a fuel injection valve disposed to the throttle body and having a two-direction nozzle configured to inject fuel uniformly to inside of the intake port or to an inner wall surface of the intake port of each of the cylinders through the opening of the intake manifold, the two-direction nozzle being disposed to oppose each other and facing outward.

17. The fuel supply device for the V-type two-cylinder general-purpose engine according to claim 16, further comprising:
a throttle valve disposed to the intake hole formed in the throttle body upstream of the fuel injection valve.

18. The fuel supply device for the V-type two-cylinder general-purpose engine according to claim 15, wherein
the intake manifold has a connection portion formed therein to which a vaporizer can be attached in place of the throttle body.

19. The fuel supply device for the V-type two-cylinder general-purpose engine according to claim 16, wherein
an injection direction of each of nozzles of the fuel injection valve having the two-direction nozzle is configured to be at a predetermined angle relative to an axial center of the injection valve so as to maintain a fixed relationship in advance corresponding to an attachment angle formed by the axial center of the fuel injection valve and an axial center of the intake hole formed in the throttle body, and
the fuel injected from the two-direction nozzle is injected uniformly to the diverged opening of the intake manifold.

20. The fuel supply device for the V-type two-cylinder general-purpose engine according to claim 16, wherein
the injection direction of each of the nozzles of the fuel injection valve having the two-direction nozzle is configured to be at a predetermined angle relative to the axial center of the injection valve so as to maintain the fixed relationship in advance corresponding to the attachment angle formed by the axial center of the fuel injection valve and the axial center of the intake hole formed in the throttle body,
the fuel injected from the two-direction nozzle is injected uniformly to the diverged opening of the intake manifold,
the injection direction of each of the nozzles of the fuel injection valve having the two-direction nozzle is configured to be at a predetermined three-dimensional angle relative to the axial center of the injection valve so as to maintain a fixed relationship in advance corresponding to the attachment angle formed by the axial center of the fuel injection valve and the axial center of the intake hole formed in the throttle body, and
the fuel injected from the two-direction nozzle is applicable to an intake manifold installed in a vertical output shaft type engine and an intake manifold installed in a horizontal output shaft type engine by configuring such that the fuel injection valve is attachable by inverting by 180 degrees in a direction orthogonal to the axial center of the intake hole of the throttle body.
